(19) United States
(12) Patent Application Publication
(10) Pub. No.: US 2015/0222863 A1
(43) Pub. Date: Aug. 6, 2015

(54) PROJECTOR

(71) Applicant: SEIKO EPSON CORPORATION, Tokyo (JP)

(72) Inventor: Yasushi KAWAKAMI, Chino-shi (JP)

(21) Appl. No.: 14/612,116

(22) Filed: Feb. 2, 2015

(30) Foreign Application Priority Data
Feb. 3, 2014 (JP) 2014-018259

(51) Int. Cl. H04N 9/31

(52) U.S. Cl. CPC H04N 9/3155; H04N 9/3147; H04N 9/3197

(57) ABSTRACT

A projector includes a modulation optical system that modulates light emitted from an illumination optical system and a vibration device. The modulation optical system includes a first electro-optical device, a relay optical system, and a second electro-optical device that are arranged in series on an optical axis of the light emitted from the illumination optical system. The vibration device vibrates at least one of the first electro-optical device, the relay optical system, and the second electro-optical device.

### BACKGROUND

1. Technical Field

The present invention relates to a projector.

2. Related Art

A transmissive electro-optical device and a reflective electro-optical device are used in a projector. These electro-optical devices are irradiated with light, and transmissive light and reflective light modulated by the electro-optical devices are projected on a screen, thus forming a projected image. A liquid crystal device is known as such electro-optical devices used in a projector. The liquid crystal device uses dielectric anisotropy of liquid crystals and rotary polarization of light in a liquid crystal layer to form an image. In the liquid crystal device, scan lines and signal lines are arranged in an image display area, and pixels are arranged at intersection points of the scan lines and the signal lines in a matrix shape. A pixel transistor is disposed at the pixel. Supplying an image signal to each pixel through the pixel transistor forms an image.

As disclosed in JP-A-2008-203321 and JP-A-2008-242208, a technology that is called local dimming and uses two electro-optical devices is proposed to improve display quality of an image projected by a projector. In this technology, a first electro-optical device (dimming panel) performs area dimming for each area, and light in the dimmed area is incident on a second electro-optical device (video panel) to improve a ratio of a bright display to a dark display (contrast ratio).

However, a problem arises in that it is difficult for the projector disclosed in JP-A-2008-203321 to display high-definition images. When the resolution of the dimming panel is increased, display failure that is called a moire is caused by the pixels in the dimming panel and the pixels in the video panel. Meanwhile, when the resolution of the dimming panel is decreased, display failure that is called a flare occurs. This phenomenon is caused by pixels in a dimming area and an adjacent dimming area thereof having different luminances that are supposed to be the same originally. For example, when a bright full moon and a dark night sky are displayed in a first dimming area, and only the night sky is displayed in a second dimming area that is adjacent to the first dimming area, light from a light source is transmitted in the first dimming area, and light from the light source is blocked in the second dimming area. Thus, the darkness of the night sky differs in the first dimming area and in the second dimming area. Accordingly, it is difficult to control the occurrence of the moire and the flare and display with a high contrast ratio in the related art.

### SUMMARY

The invention can be realized in the following forms or application examples.

### Application Example 1

According to this application example, there is provided a projector including an illumination optical system that emits light, a modulation optical system that modulates the light emitted from the illumination optical system, a projection optical system that projects the light modulated in the modulation optical system; and a vibration device, in which the modulation optical system includes a first electro-optical device, a relay optical system, and a second electro-optical device that are arranged in series on an optical axis of the light emitted from the illumination optical system, the relay optical system is arranged on an optical path between the first electro-optical device and the second electro-optical device, and the vibration device vibrates at least one of the first electro-optical device, the relay optical system, and the second electro-optical device.

Increasing the resolution of the first electro-optical device can suppress flares while causing moires to occur. In this case, the moires caused are vibrated even though the resolution of the first electro-optical device is increased. Thus, the moires are suppressed when the moires are temporally averaged across one vibration cycle. Accordingly, a user who sees a projected image cannot visually recognize the moires when one vibration cycle is set to a short time. For this reason, moires and flares can be suppressed, and a high-definition image can be displayed with a high contrast ratio.

### Application Example 2

In the projector according to Application Example 1, a frequency with which the vibration device vibrates is preferably greater than or equal to a frame frequency of a video displayed in the second electro-optical device.

In this case, the user who sees the projected image cannot visually recognize moires, and a high-definition image can be displayed since one vibration cycle is set to a short time.

### Application Example 3

In the projector according to Application Example 1 or 2, the amplitude with which the vibration device vibrates is preferably smaller than or equal to a dislocation length of an assembly of the first electro-optical device and the second electro-optical device.

In this case, a clear and high-resolution image can be displayed since the amplitude is small.

### Application Example 4

In the projector according to Application Example 1 or 2, the second electro-optical device preferably includes a pixel, and the amplitude with which the vibration device vibrates is preferably smaller than or equal to half a length of the pixel.

In this case, a clear and high-resolution image can be displayed since the amplitude is small.

### Application Example 5

In the projector according to any one of Application Examples 1 to 4, a direction in which the vibration device vibrates is preferably parallel to a plane that is perpendicular to the optical axis.

In this case, moires can be suppressed.

### Application Example 6

In the projector according to Application Example 5, the direction in which the vibration device vibrates is preferably translational.

In this case, moires can be suppressed.

### Application Example 7

In the projector according to Application Example 5, the direction in which the vibration device vibrates is preferably rotational around an axis that is parallel to the optical axis.

In this case, moires can be suppressed.

### Application Example 8

In the projector according to any one of Application Examples 1 to 7, the direction in which the vibration device vibrates is preferably rotational around an arbitrary axis in a plane that is perpendicular to the optical axis.

In this case, moires can be suppressed.

### Application Example 9

According to this application example, there is provided a projector including an illumination optical system that emits light, a modulation optical system that modulates the light emitted from the illumination optical system, and a projection optical system that projects the light modulated in the modulation optical system, in which the modulation optical system includes a first electro-optical device, a relay optical system, a shift optical system, and a second electro-optical device that are arranged in series on an optical axis of the light emitted from the illumination optical system, the relay optical system is arranged on an optical path between the first electro-optical device and the second electro-optical device, and the shift optical system is arranged on the optical path between the first electro-optical device and the second electro-optical device and vibrates luminous flux that is incident on the second electro-optical device.

Increasing the resolution of the first electro-optical device can suppress flares while causing moires to occur. In this case, the moires caused are vibrated even though the resolution of the first electro-optical device is increased. Thus, the moires are suppressed when the moires are temporally averaged across one vibration cycle. Accordingly, a user who sees a projected image cannot visually recognize the moires when one vibration cycle is set to a short time. For this reason, moires and flares can be suppressed, and a high-definition image can be displayed with a high contrast ratio.

### Application Example 10

In the projector according to Application Example 9, a frequency with which the shift optical system vibrates the luminous flux is preferably greater than or equal to a frame frequency of a video displayed in the second electro-optical device.

In this case, the user who sees the projected image cannot visually recognize moires, and a high-definition image can be displayed since one vibration cycle is set to a short time.

### Application Example 11

In the projector according to Application Example 9 or 10, an amplitude with which the shift optical system vibrates the luminous flux is preferably smaller than or equal to a dislocation length of an assembly of the first electro-optical device and the second electro-optical device.

In this case, a clear and high-resolution image can be displayed since the amplitude is small.

### Application Example 12

In the projector according to Application Example 9 or 10, the second electro-optical device preferably includes a pixel, and an amplitude with which the shift optical system vibrates the luminous flux is preferably smaller than or equal to half a length of the pixel.

In this case, a clear and high-resolution image can be displayed since the amplitude is small.

### Application Example 13

In the projector according to any one of Application Examples 9 to 12, a direction in which the shift optical system vibrates the luminous flux is preferably parallel to a plane that is perpendicular to the optical axis.

In this case, moires can be suppressed.

### Application Example 14

In the projector according to Application Example 13, the direction in which the shift optical system vibrates the luminous flux is preferably translational.

In this case, moires can be suppressed.

### Application Example 15

In the projector according to Application Example 13, the direction in which the shift optical system vibrates the luminous flux is preferably rotational around an axis that is parallel to the optical axis.

In this case, moires can be suppressed.

### Application Example 16

In the projector according to any one of Application Examples 1 to 15, the second electro-optical device is preferably transmissive.

In this case, an image displayed in the second electro-optical device can be projected on a screen to form a projected image.

### Application Example 17

In the projector according to any one of Application Examples 1 to 15, the second electro-optical device is preferably reflective.

In this case, an image displayed in the second electro-optical device can be projected on a screen to form a projected image.

### BRIEF DESCRIPTION OF THE DRAWINGS

The invention will be described with reference to the accompanying drawings, wherein like numbers reference like elements.

FIG. 1 is a diagram illustrating the schematic optical configuration of a projector according to a first embodiment.

FIG. 2 is a diagram illustrating an example of an optical system from a first electro-optical device to a second electro-optical device according to the first embodiment.

FIG. 3 is a circuit block diagram of an electro-optical device.

FIG. 4 is a circuit diagram of a pixel.

FIG. 5 is a schematic cross-sectional diagram of a liquid crystal device.

FIG. 6 is a diagram illustrating an example of the optical system from the first electro-optical device to the second electro-optical device according to the first embodiment.

FIG. 7 is a diagram illustrating an example of an optical system from a first electro-optical device to a second electro-optical device according to a second embodiment.

### DESCRIPTION OF EXEMPLARY EMBODIMENTS

Hereinafter, embodiments of the invention will be described with reference to the accompanying drawings. Each layer and each member are illustrated to a recognizable extent in each drawing and thus, are scaled differently from the actual size thereof.

### First Embodiment

### Optical Configuration

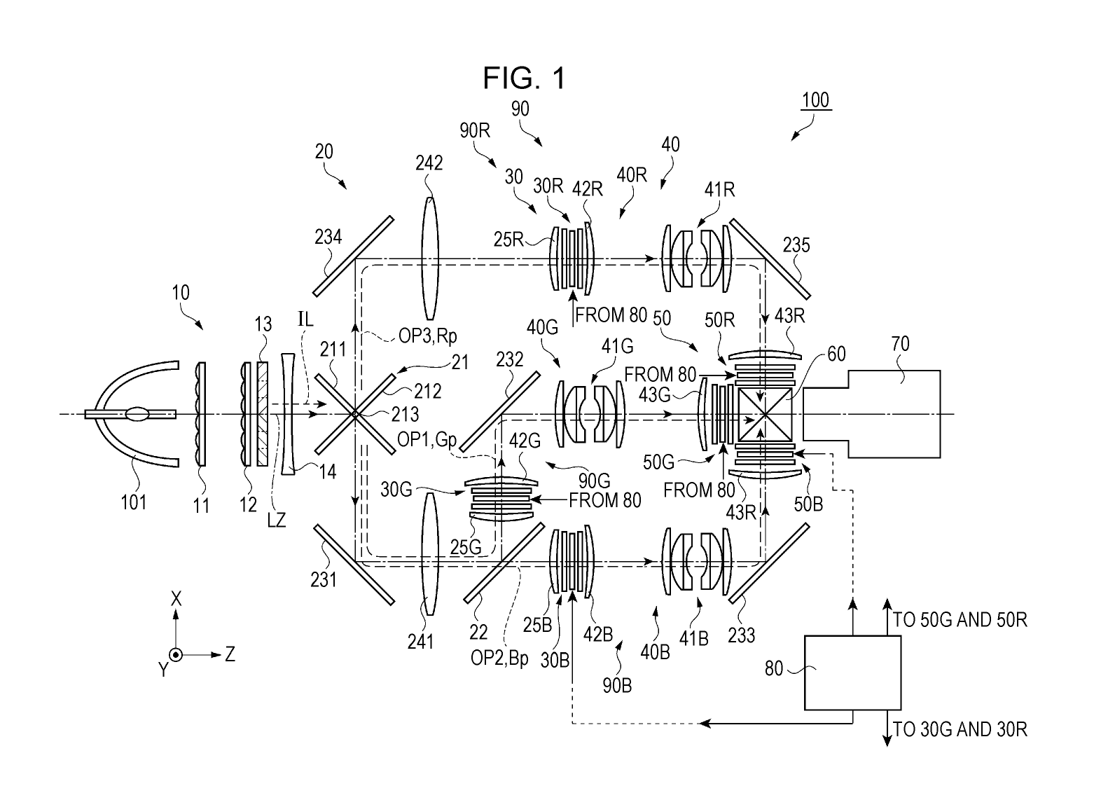

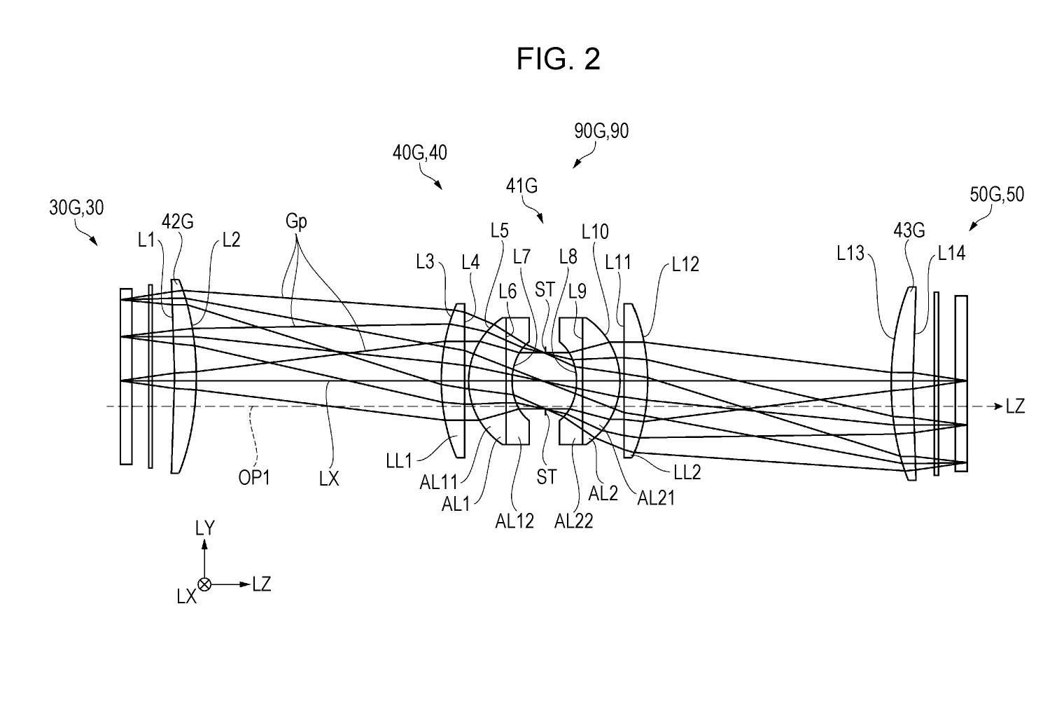

FIG. 1 is a diagram illustrating the schematic optical configuration of a projector according to a first embodiment. FIG. 2 is a diagram illustrating an example of an optical system from a first electro-optical device to a second electro-optical device. First, the configuration of a projector 100 will be described with reference to FIG. 1 and FIG. 2. The optical configuration is mainly depicted, and the mechanical configuration is omitted in FIG. 1.

As illustrated in FIG. 1, the projector 100 according to the first embodiment includes an illumination optical system 10 that emits illumination light, a color separation light-guiding optical system 20 that separates the illumination light into each color light and guides the color light, a modulation optical system 90 that modulates each color light which is emitted from the illumination optical system 10 and separated in the color separation light-guiding optical system 20, a composite optical system 60 that composites the color light (modulated light) which is separated and modulated, a projection optical system 70 that projects the composited light, a projector control unit 80, and an unillustrated vibration device. The modulation optical system 90 includes a dimming system 30 which includes the first electro-optical device, a relay optical system 40 that is in charge of relaying an optical path from the first electro-optical device to the second electro-optical device, and an image display system 50 which includes the second electro-optical device. The projector control unit 80 controls drive of the first electro-optical device and the second electro-optical device and operation of the vibration device. The present specification adopts a local orthogonal coordinate system LX-LY-LZ. Optical axes in all of the optical systems of the projector 100 are directed in the LZ direction all the time (hereinafter, described as the optical axis LZ). Accordingly, a plane that is perpendicular to the optical axis LZ (optical axis perpendicular plane) is the LX-LY plane. Furthermore, absolute spatial coordinates are represented in an orthogonal coordinate system X-Y-Z. As illustrated in FIG. 1, the direction of the optical axis LZ may differ in the absolute orthogonal coordinate system X-Y-Z depending on a place.

The illumination optical system 10 includes a light source 101, a first lens array (first integrator lens) 11 that has a plurality of lens elements arranged in an array shape, a second lens array (second integrator lens) 12, a polarization conversion element 13 that converts light from the second lens array 12 into predetermined linearly polarized light, and a superimposition lens 14. The illumination optical system 10 emits a necessary amount of illumination light for forming an image. The light source 101, for example, is an extra-high-pressure mercury lamp and emits light that includes red light Rp, green light Gp, and blue light Bp. Besides the extra-high-pressure mercury lamp, the light source 101 may be an electric discharge light source or may be a solid-state light source such as an LED and a laser. The first lens array 11 and the second lens array 12 plurally divide or condense luminous flux from the light source 101. The polarization conversion element 13 cooperates with the superimposition lens 14 to form illumination light so that the illumination light is superimposed on an illumination target area of a dimming light valve that constitutes the dimming system 30.

The color separation light-guiding optical system 20 includes a cross-dichroic mirror 21; a dichroic mirror 22, fold mirrors 231, 232, 233, 234, and 235; first lenses 241 and 242; and second lenses 25G, 25R, and 25B. Here, the cross-dichroic mirror 21 includes a first dichroic mirror 211 and a second dichroic mirror 212. The first and the second dichroic mirrors 211 and 212 are orthogonal to each other, and an intersection axis 213 thereof extends in the Y direction. The color separation light-guiding optical system 20 separates illumination light from the illumination optical system 10 into three colors of light of green, red, and blue and guides each color light.

The modulation optical system 90 is configured of a plurality of modulation optical systems that respectively corresponds to the three colors of separated light. The modulation optical system 90 includes the dimming system 30 that is relatively positioned on an upstream side of the optical axis LZ, an image display system 50 that is relatively positioned on a downstream side of the optical axis LZ, and the relay optical system 40 that is arranged between the dimming system 30 and the image display system 50.

The dimming system 30 of the modulation optical system 90 includes three first electro-optical devices (dimming light valves 30G, 30R, and 30B) that respectively correspond to the three colors (green, red, and blue) of light separated by the color separation light-guiding optical system 20. In the present embodiment, the dimming light valves 30G, 30R, and 30B are transmissive liquid crystal devices and are non-emissive optical modulation devices that respectively adjust the intensities of the color light. Specifically, the liquid crystal device (first electro-optical device) configured of the dimming light valves 30G, 30R, and 30B includes a pair of substrates with a liquid crystal interposed therebetween, an incident-side polarization plate disposed on a side of the pair of substrates where light is incident, and an emitting-side polarization plate disposed on a side of the pair of substrates where light is emitted for each of the dimming light valves 30G, 30R, and 30B. The incident-side polarization plate and the emitting-side polarization plate are arranged as crossed Nicols. The three dimming light valves 30G, 30R, and 30B respectively modulate the three colors of light to form a dimming image according to dimming information (dimming signal) that is input.

The relay optical system 40 of the modulation optical system 90 is configured of three optical systems 40G, 40R, and 40B that respectively correspond to the three dimming light valves 30G, 30R, and 30B which constitute the dimming system 30. The optical system 40G, for example, includes a double gauss lens 41G and a pair of meniscus lenses 42G and 43G. Although described in detail below, the pair of meniscus lenses 42G and 43G is positive and is arranged to interpose the double gauss lens 41G therebetween on the optical axis LZ. Each of the meniscus lenses 42G and 43G is arranged to be convex toward the double gauss lens 41G side. That is, the convex surface thereof faces the double gauss lens 41G side. Other optical systems 40R and 40B respectively include double gauss lenses 41R and 41B and pairs of meniscus lenses 42R, 43R and 42B, 43B, all of which have the same structure as those of the optical system 40G.

The image display system 50 of the modulation optical system 90 includes three second electro-optical devices (color modulation light valves 50G, 50R, and 50B) that respectively correspond to the three colors (green, red, and blue) of light relayed via the relay optical system 40. In the present embodiment, the color modulation light valves 50G, 50R, and 50B are transmissive liquid crystal devices and are non-emissive optical modulation units that modulate spatial distribution of the intensity of each color light which is the incident illumination light. Specifically, the liquid crystal device (second electro-optical device) configured of the color modulation light valves 50G, 50R, and 50B includes a pair of substrates with a liquid crystal interposed therebetween, an incident-side polarization plate disposed on a side of the pair of substrates where light is incident, and an emitting-side polarization plate disposed on a side of the pair of substrates where light is emitted for each of the dimming light valves 30G, 30R, and 30B. The three color modulation light valves 50G, 50R, and 50B respectively modulate the three colors of light to form a display image according to image information (image signal) that is input.

The above modulation optical system 90 can be also regarded as being configured of three modulation optical systems 90G, 90R, and 90B. That is, the modulation optical system 90G is arranged to correspond to the green light Gp and includes the dimming light valve 30G, the optical system 40G, and the color modulation light valve 50G. Similarly, the modulation optical system 90R is arranged to correspond to the red light Rp and includes the dimming light valve 30R, the optical system 40R, and the color modulation light valve 50R. The modulation optical system 90B is arranged to correspond to the blue light Bp and includes the dimming light valve 30B, the optical system 40B, and the color modulation light valve 50B. When the modulation optical system 90 is regarded as the three modulation optical systems 90G, 90R, and 90B, one modulation optical system (for example, the modulation optical system 90G) has the dimming light valve (dimming light valve 30G) that corresponds to the first electro-optical device, the relay optical system (optical system 40G), and the color modulation light valve (color modulation light valve 50G) that corresponds to the second electro-optical device arranged therein in this order along the optical axis LZ. That is, the dimming light valve and the color modulation light valve that are in a corresponding relationship are arranged in series on the optical axis.

The composite optical system 60 is a cross-dichroic prism formed of four right prisms attached to each other. The composite optical system 60 composites the modulated light of each color that is modulated in the color modulation light valves 50G, 50R, and 50B which constitute the image display system 50 and emits the composited light toward the projection optical system 70.

The projection optical system 70 projects the composited light that is modulated in the color modulation light valves 50G, 50R, and 50B which are the modulation optical system and is further composited in the composite optical system 60 toward a subject (not illustrated) such as a screen.

The unillustrated vibration device vibrates at least one of the first electro-optical device, the relay optical system 40, and the second electro-optical device. In the present embodiment, the three dimming light valves 30G, 30R, and 30B that are the first electro-optical device are independently vibrated. Vibration by the vibration device will be described in detail below.

Hereinafter, formation of image light will be described in detail. First, illumination luminous flux IL is emitted from the illumination optical system 10 as the illumination light. Next, in the color separation light-guiding optical system 20, the first dichroic mirror 211 of the cross-dichroic mirror 21 reflects the green light Gp and the blue light Bp included in the illumination luminous flux IL and transmits the remaining red light Rp. The second dichroic mirror 212 of the cross-dichroic mirror 21 reflects the red light Rp and transmits the green light Gp and the blue light Bp. The dichroic mirror 22 reflects the green light Gp between the incident green light Gp and the blue light Bp and transmits the remaining blue light Bp. To describe the light of each color (the green light Gp, the blue light Bp, and the red light Rp) separated from the illumination luminous flux IL by the color separation light-guiding optical system 20 in detail along optical axes OP1 to OP3 of each color, first, the illumination luminous flux IL from the illumination optical system 10 is incident on the cross-dichroic mirror 21 and is separated. The green light Gp (optical axis OP1) among the components of the illumination luminous flux IL is reflected or branches at the first dichroic mirror 211 of the cross-dichroic mirror 21. Then, the green light Gp branches by being further reflected on the dichroic mirror 22 via the fold mirror 231 and is incident on the dimming light valve 30G among the three dimming light valves of the dimming system 30 that corresponds to the green light Gp. The blue light Bp (optical axis OP2) among the components of the illumination luminous flux IL is reflected or branches at the first dichroic mirror 211 of the cross-dichroic mirror 21. Then, the blue light Bp branches by passing through the dichroic mirror 22 via the fold mirror 231 and is incident on the dimming light valve 30B among the three dimming light valves of the dimming system 30 that corresponds to the blue light Bp. The red light Rp (optical axis OP3) among the components of the illumination luminous flux IL is reflected or branches at the second dichroic mirror 212 of the cross-dichroic mirror 21. Then, the red light Rp is incident on the dimming light valve 30R among the three dimming light valves of the dimming system 30 that corresponds to the red light Rp via the fold mirror 234. As described above, the dimming light valves 30G, 30R, and 30B that constitute the dimming system 30 respectively adjust the intensities of the green light Gp, the red light Rp, and the blue light Bp under control of the projector control unit 80. The first lenses 241 and 242 and the second lenses 25G, 25R, and 25B that are arranged on the optical axes OP1 to OP3 are respectively disposed so as to adjust the angular state of color light (the green light Gp, the red light Rp, and the blue light Bp) that is incident on the corresponding dimming light valves 30G, 30B, and 30R.

Each of the color light (the green light Gp, the red light Rp, and the blue light Bp) of which the luminance is adjusted via the dimming system 30 is respectively incident on the three color modulation light valves 50G, 50R, and 50B that constitute the image display system 50 respectively via the optical systems 40G, 40R, and 40B that constitute the relay optical system 40 and are arranged to correspond to each color. That is, the green light Gp emitted from the dimming light valve 30G is incident on the color modulation light valve 50G via the optical system 40G and the fold mirror 232. The blue light Bp emitted from the dimming light valve 30B is incident on the color modulation light valve 50B via the optical system 40B and the fold mirror 233. The red light Rp emitted from the dimming light valve 30R is incident on the color modulation light valve 50R via the optical system 40R and the fold mirror 235. As described above, the color modulation light valves 50G, 50R, and 50B that constitute the image display system 50 form an image of each color by respectively modulating the three colors of light under the control of the projector control unit 80. The modulated light of each color that is respectively modulated in the color modulation light valves 50G, 50R, and 50B is composited in the composite optical system 60 and is projected by the projection optical system 70.

In the above-described case, the lengths of the optical axes OP1 to OP3 of each color light are substantially equal to each other.

As described above, the projector 100 has serial arrangement of the dimming light valves 30G, 30R, and 30B (first electro-optical device) that are luminance modulation elements arranged on the upstream side of the optical axis LZ and the color modulation light valves 50G, 50R, and 50B (second electro-optical device) that are color modulation elements arranged on the downstream side of the optical axis LZ along the optical axis LZ of each color. Here, it is necessary for the first electro-optical device and the second electro-optical device that correspond to each other (for example, the dimming light valve 30G and the color modulation light valve 50G) to be substantially in an imaging relationship. Meanwhile, in general, it is not necessarily easy to maintain the imaging state between the two electro-optical devices with high accuracy by suppressing occurrence of various aberrations. Also, it is not necessarily easy for the devices to be miniaturized and have favorable telecentricity. For example, using a unit magnification optical system as the relay optical system arranged between the first electro-optical device and the second electro-optical device allows an image of the first electro-optical device to be imaged in such a manner that the image is superimposed corresponding to the second electro-optical device one-on-one. In this case, for example, occurrence of coma aberrations and distortion among the various aberrations can be suppressed to some extent. However, the configuration with the unit magnification cannot be sufficient for resolving occurrence of image plane curvature and astigmatism. In addition, for example, applying a double gauss lens between the two electro-optical devices is considered to avoid the devices increasing in size and improve accuracy in resolving, for example, chromatic aberrations and the like. However, using the double gauss lens cannot sufficiently suppress, for example, the occurrence of image plane curvature and astigmatism among the various aberrations and thus, cannot maintain the imaging state with sufficiently high accuracy. On the contrary, the relay optical system is arranged on the optical path between the first electro-optical device and the second electro-optical device in the present embodiment. Specifically, the relay optical system 40 is disposed between the dimming system 30 configured of the dimming light valves 30G, 30R, and 30B and the image display system 50 configured of the color modulation light valves 50G, 50R, and 50B. In addition, not only the double gauss lenses 41G, 41R, and 41B are disposed, but also the pairs of convex meniscus lenses 42G, 43G; 42R, 43R; and 42B, 43B are respectively disposed in the optical systems 40G, 40R, and 40B of each color that constitute the relay optical system 40. Accordingly, the devices can be miniaturized and have favorable telecentricity, and the imaging state can be maintained with high accuracy to form a favorable image.

FIG. 2 is a diagram illustrating an example of an optical system (the optical system along the optical axis OP1 in this example) from the first electro-optical device to the second electro-optical device according to the first embodiment. Here, the traveling direction of light is set to the +LZ direction. In addition, in FIG. 2, the imaging state of the illumination light (the green light Gp in this example) is illustrated particularly with the relay optical system 40 (the optical system 40G in this example) as the center among the dimming system 30 (the dimming light valve 30G in this example), the relay optical system 40 (the optical system 40G in this example), and the image display system 50 (the color modulation light valve 50G in this example) that constitute the modulation optical system 90 (the modulation optical system 90G in this example) along one optical axis LZ (the optical axis OP1 in this example) among the three optical axes LZ that branch by color separation. As described above, the lengths of the optical axes LZ of each color are substantially equal to each other in the present embodiment. Other optical axes LZ (for example, the optical axes OP2 and OP3) are the same as that in FIG. 2 when developed in a diagram, and thus, illustration and description thereof will be omitted.

As described above, the optical system 40G includes the double gauss lens 41G and the pair of meniscus lenses 42G and 43G. Describing each unit of the optical system 40G specifically with reference to FIG. 2, first, the double gauss lens 41G is configured to have a first lens LL1, a first achromatic lens AL1, a stop ST, a second achromatic lens AL2, and a second lens LL2 in this order from the incident side along the optical axis LZ. In addition, each of the first achromatic lens AL1 and the second achromatic lens AL2 is configured of two lenses combined with each other. That is, the first achromatic lens AL1 is configured of a lens AL11 and a lens AL12 attached to each other, and the second achromatic lens AL2 is configured of a lens AL21 and a lens AL22 attached to each other. Accordingly, the first achromatic lens AL1 and the second achromatic lens AL2 have total three lens surfaces of the outer surface, the inner surface, and the attached surface.

The pair of meniscus lenses 42G and 43G is a lens having positive refractive power and has the same shape. The pair of meniscus lenses 42G and 43G is symmetrically arranged with the double gauss lens 41G as a reference so as to interpose the double gauss lens 41G therebetween and particularly, is arranged to be convex toward the double gauss lens 41G side. That is, the meniscus lens 42G that is a first meniscus lens arranged at a rear stage of the dimming light valve 30G is convex toward the downstream side of the optical axis LZ, and the meniscus lens 43G that is a second meniscus lens arranged at a front stage of the color modulation light valve 50G is convex toward the upstream side of the optical axis LZ.

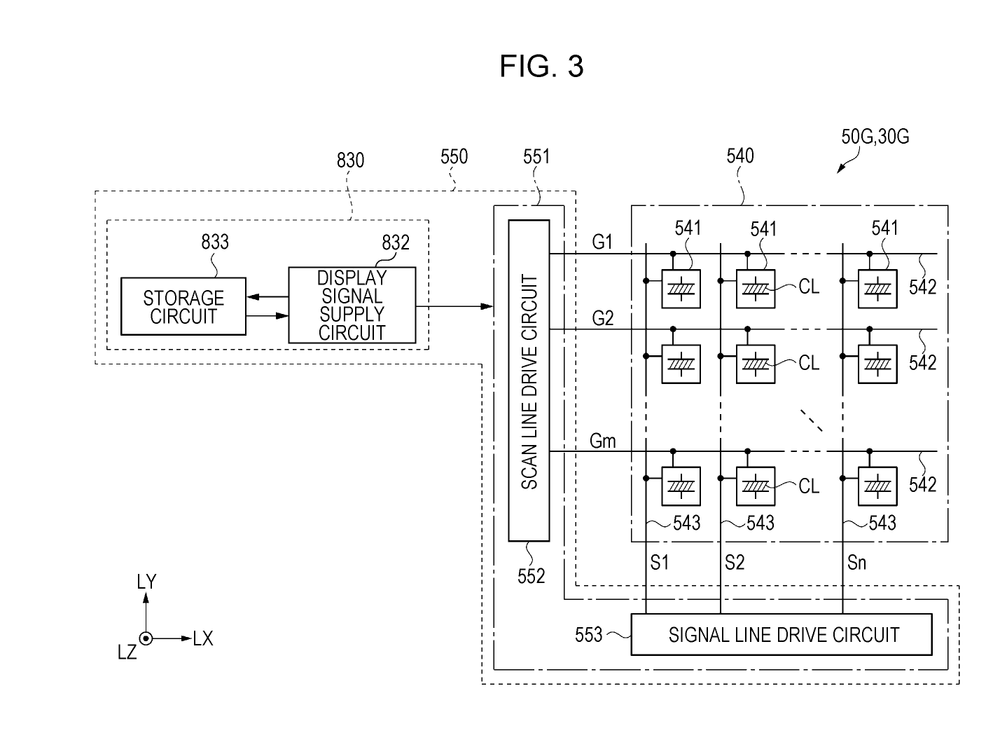

The optical system 40G including the double gauss lens 41G is a unit magnification optical system that is symmetrical along the optical axis LZ with the position of the stop ST of the double gauss lens 41G as a reference. That is, the optical system 40G has a configuration of lenses arranged symmetrically to the stop ST as a symmetrical plane. In other words, the optical system 40G has an optical system arranged on the upstream side of the optical axis LZ and an optical system arranged on the downstream side of the optical axis LZ with the stop ST as the center, all of which have the same shape, material, and arrangement and are aligned so as to mirror each other. Accordingly, for example, the size of a display area 540 (refer to FIG. 3) of the first electro-optical device and the size of the display area 540 (refer to FIG. 3) of the second electro-optical device are the same in design.

Among the constituents of the optical system 40G, the meniscus lens 42G arranged on an upstream side of the stop ST on the optical axis LZ includes a lens surface L1 and a lens surface L2, the first lens LL1 includes a lens surface L3 and a lens surface L4, and the first achromatic lens AL1 includes a lens surface L5, a lens surface L6, and a lens surface L7. In addition, among the constituents of the optical system 40G, the second achromatic lens AL2 arranged on a downstream side of the stop ST on the optical axis LZ includes a lens surface L8, a lens surface L9, and a lens surface L10, the second lens LL2 includes a lens surface L11 and a lens surface L12, and the meniscus lens 43G includes a lens surface L13 and a lens surface L14. For example, the lens surface L1 that is the initial surface and the lens surface L14 that is the last surface of these lens surfaces are symmetric with the position of the stop ST as a reference. Similarly, the lens surface L2 corresponds to the lens surface L13, and the lens surface L3 corresponds to the lens surface L12. The same applies to the other lens surfaces.

As illustrated in FIG. 2, the green light Gp emitted from the dimming light valve 30G is imaged in the color modulation light valve 50G through each of the above lens surfaces L1 to L14.

Here, given that f_{dg} is the focal length of the double gauss lens 41G, fₗ is the focal length of the meniscus lens 42G that is the first meniscus lens arranged on the light-incident side, and f₂ is the focal length of the meniscus lens 43G that is the second meniscus lens arranged on the light-emitted side of the pair of meniscus lenses 42G and 43G in the above relay optical system 40 (optical system 40G), Expression 1 is satisfied.

$$1.7 \leq \frac{( {f}_{1} + {f}_{2} ) / 2}{{f}_{d g}} \leq 2.1 \qquad Expression 1$$

Configuring each lens of the optical system 40G within a range that satisfies Expression 1 allows both sides of the optical system 40G that constitutes the relay optical system 40 to be telecentric and can effect the sufficient correction of aberrations by the pair of meniscus lenses 42G and 43G. The above description is also applied in the same manner to the other optical systems 40R and 40B that constitute the relay optical system 40.

As described above, the projector 100 according to the present embodiment sufficiently suppresses aberrations that may occur between the dimming light valves 30G, 30R, and 30B and the color modulation light valves 50G, 50R, and 50B, maintains the high-performance imaging state, and further forms an image favorably by the relay optical system (the optical systems 40G, 40R, and 40B) having the double gauss lenses 41G, 41R, and 41B and the pairs of meniscus lenses 42G, 43G; 42R, 43R; and 42B, 43B that are respectively arranged to be convex toward these double gauss lenses 41G, 41R, and 41B. In addition, configuring the relay optical system, which is for maintaining the favorable imaging state, comparatively simply with the double gauss lenses 41G, 41R, and 41B and the pairs of meniscus lenses 42G, 43G; 42R, 43R; and 42B, 43B suppresses the devices increasing in size. Furthermore, structuring each of the optical systems 40G, 40R, and 40B that constitutes the relay optical system 40 symmetrically with the position of the stop ST as a reference allows the devices to maintain telecentricity.

The resolution of the dimming light valves 30G, 30R, and 30B that constitute the dimming system 30 and the resolution of the color modulation light valves 50G, 50R, and 50B that constitute the image display system 50 can correspond to each other one-on-one in the above example. That is, for example, the resolution of the dimming light valve 30G can match the resolution of the color modulation light valve 50G that corresponds to the dimming light valve 30G. Not limited to this, the resolution of the color modulation light valves 50G, 50R, and 50B, for example, may be higher than the resolution of the dimming light valves 30G, 30R, and 30B. That is, for example, one pixel 541 (refer to FIG. 3) of the dimming light valve 30G that is the first electro-optical device and is arranged on the upstream side of the optical axis LZ may correspond to a plurality of pixels 541 of the color modulation light valve 50G that is the second electro-optical device and is arranged on the downstream side of the optical axis LZ. In this case, luminance in the dimming light valve 30G is adjusted for each dimming area that corresponds to the plurality of pixels 541 of the color modulation light valve 50G, and luminance in the color modulation light valve 50G is adjusted for each pixel. Although the electro-optical device will be described in detail below, when the m₂-row by n₂-column pixels 541 are arranged in the display area 540 (refer to FIG. 3) of the second electro-optical device, and the m₁-row by n₁-column pixels 541 are arranged in the display area 540 of the first electro-optical device, it is preferable that 1/120<m₁/m₂≦1 and 1/120<n₁/n₂ 1. For example, when m₂=1088 and n₂=1928, it is preferable that 9<m₁≦1088 and 16<n₁≦1928.

Furthermore, the first electro-optical device and the second electro-optical device may be configured to have a reverse relationship between the upstream side of the optical axis LZ and the downstream side of the optical axis LZ. In addition, the number of gradations (for example, 256 gradations) is the same in the dimming light valves 30G, 30R, and 30B and the color modulation light valves 50G, 50R, and 50B in the above example but may be different.

### Circuit Configuration

FIG. 3 is a circuit block diagram of the electro-optical device. Next, the configuration of circuit blocks of the electro-optical device that is the first electro-optical device and the second electro-optical device will be described with reference to FIG. 3. The first electro-optical device and the second electro-optical device have the same configuration other than the number of pixels thereof, and the three dimming light valves 30G, 30R, and 30B and the three color modulation light valves 50G, 50R, and 50B have the same configuration. Thus, description will be made below with only the dimming light valve 30G and the color modulation light valve 50G depicted as an example in FIG. 3.

As illustrated in FIG. 3, the electro-optical device (the dimming light valve 30G and the color modulation light valve 50G) is provided with at least the display area 540 and a drive unit 550. Furthermore, the electro-optical device includes a mounting area 520 (refer to FIG. 5). In the display area 540 of the electro-optical device, a plurality of scan lines 542 and a plurality of signal lines 543 are formed to intersect each other, and the pixel 541 is arranged in a matrix shape to correspond to each intersection of the scan line 542 and the signal line 543. The scan line 542 extends in the direction of rows, and the signal line 543 extends in the direction of columns. In the present specification, the direction of rows is set to a direction that is parallel to the LX axis, and the direction of columns is set to a direction that is parallel to the LY axis. A notation scan line Gi is used to specify the i-th-row scan line 542 among the scan lines 542, and a notation signal line Sj is used to specify the j-th-column signal line 543 among the signal lines 543. The first electro-optical device has m₁ lines of the scan line 542 and n₁ lines of the signal line 543 formed in the display area 540 thereof (where m₁ and n₁ are integers greater than or equal to two), and the second electro-optical device has m₂ lines of the scan line 542 and n₂ lines of the signal line 543 formed in the display area 540 thereof (where m₂ and n₂ are integers greater than or equal to two). In FIG. 3, m₁ and m₂ are representatively denoted by m, and n₁ and n₂ are representatively denoted by n. Hereafter, the scan line 542 will be described to be m lines, and the signal line 543 will be described to be n lines when it is not necessary to distinguish the first electro-optical device and the second electro-optical device. In the present embodiment, m₁=272, n₁=482, m₂=1088, and n₂=1928. In this case, a 1080-row×1920-column image that is a so-called HD image is displayed in the 1088-row×1928-column display area 540 of the second electro-optical device. The diagonal length of the display area 540 of the first electro-optical device and the second electro-optical device is 0.9 inches (18.35 mm), and the pixel 541 of the second electro-optical device is a square with one edge of 10.4 microns (μm) long. In addition, the pixel 541 of the first electro-optical device is a square with one edge of 61.6 microns (μm). Accordingly, one dimming area that is one pixel 541 of the first electro-optical device includes 16 pixels 541 of the second electro-optical device.

Various signals are supplied to the display area 540 from the drive unit 550, and an image is displayed in the display area 540. That is, the drive unit 550 supplies a drive signal to the plurality of scan lines 542 and the plurality of signal lines 543. Specifically, the drive unit 550 is configured to include a drive circuit 551 that drives each pixel 541, a display signal supply circuit 832 that supplies a display signal to the drive circuit 551, and a storage circuit 833 that temporarily stores a frame image. The display signal supply circuit 832 creates the display signal (an image signal, a clock signal, and the like) from the frame image stored in the storage circuit 833 and supplies the display signal to the drive circuit 551. The display signal supply circuit 832 also creates a precharge signal and supplies the precharge signal to the drive circuit 551.

The drive circuit 551 is configured to include a scan line drive circuit 552 and a signal line drive circuit 553. The scan line drive circuit 552 outputs a scan signal for selecting or not selecting a pixel in the direction of rows to each scan line 542, and the scan line 542 transports the scan signal to the pixel 541. In other words, the scan signal has a selection state and a non-selection state, and the scan line 542 may appropriately select the pixel 541 by receiving the scan signal from the scan line drive circuit 552. The scan line drive circuit 552 includes an unillustrated shift register circuit. A signal that shifts the shift register circuit is output for each stage of the shift register circuit as a shift output signal. The shift output signal is used to form the scan signal. The signal line drive circuit 553 can supply the precharge signal and the image signal to each of the n lines of the signal line 543 synchronized with the selection of the scan line 542.

One display image is formed during one frame period (frame cycle). Each scan line 542 is selected at least once during one frame period. Normally, each scan line 542 is selected once. A period during which one scan line 542 is selected is called a horizontal scan period. Thus, one frame period includes at least m horizontal scan periods. The frame period is also called a vertical scan period because one frame period is configured of a period during which the scan line 542 is selected sequentially from the first-row scan line G1 to an m-th-row scan line Gm (alternatively, sequentially from the m-th-row scan line Gm to the first-row scan line G1). The lengths of one frame period in the first electro-optical device and the second electro-optical device are equal to each other. The number of display images displayed during one second is a frame frequency. Displaying display images at the frame frequency forms a video.

In the present embodiment, an element substrate 562 (refer to FIG. 5) is used to form the electro-optical device, and a thin-film element such as a thin-film transistor is used to form the drive circuit 551 on the element substrate 562. The display signal supply circuit 832 and the storage circuit 833 are included in a control device 830 and are configured of a semiconductor integrated circuit formed on a single-crystal semiconductor substrate. The control device 830 is included in the projector control unit 80. The mounting area 520 is disposed in the element substrate 562, and the display signal is supplied to the drive circuit 551 from the control device 830 through terminal PADs and flexible printed circuits (FPC) that are arranged in the mounting area 520.

### Configuration of Pixel

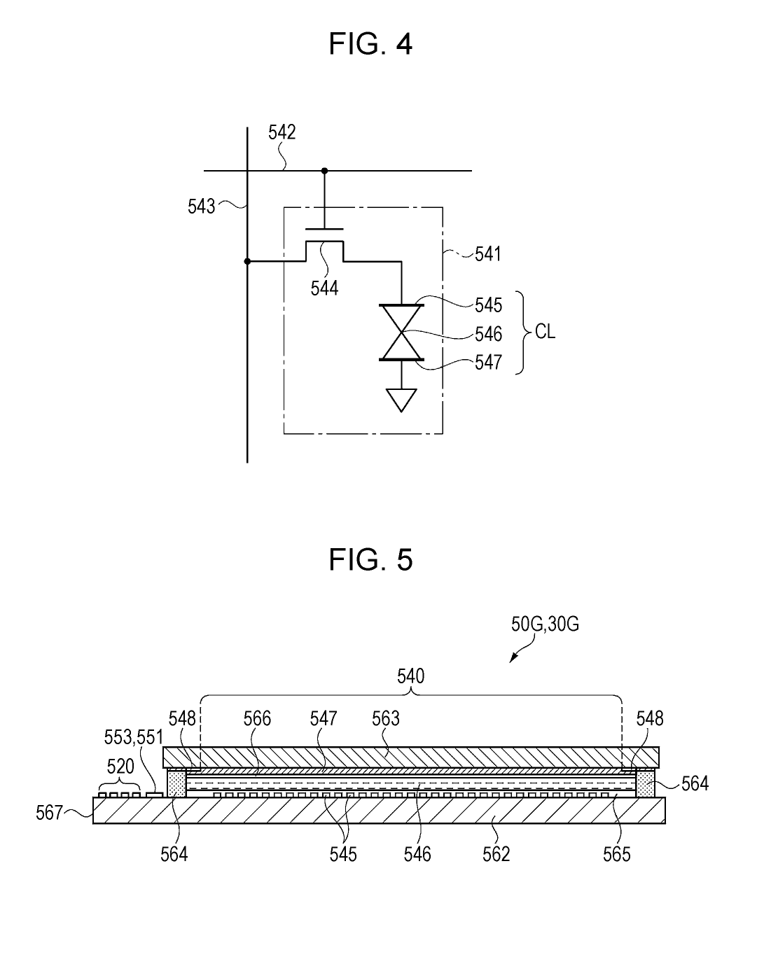

FIG. 4 is a circuit diagram of each pixel. Next, the configuration of the pixel 541 will be described with reference to FIG. 4.

The electro-optical device of the present embodiment is a liquid crystal device, and electro-optical material is formed of a liquid crystal 546. As illustrated in FIG. 4, each pixel 541 is configured to include a liquid crystal element CL and a pixel transistor 544. The liquid crystal element CL includes a pixel electrode 545 and a common electrode 547 that face each other and is an electro-optical element with the liquid crystal 546 of electro-optical material arranged between both of these electrodes. Transmissivity of light that passes through the liquid crystal 546 changes in response to an electric field applied between the pixel electrode 545 and the common electrode 547.

The pixel transistor 544 is configured of an N-type thin-film transistor of which the gate is connected to the scan line 542 and is interposed between the liquid crystal element CL and the signal line 543 to control electrical connection (conduction/non-conduction) between both the liquid crystal element CL and the signal line 543. Accordingly, the pixel 541 (liquid crystal element CL) performs displaying in response to electrical potentials (image signal) that are supplied to the signal line 543 when the pixel transistor 544 is ON. Illustration of an auxiliary capacitor and the like connected to the liquid crystal element CL in parallel is omitted in FIG. 4.

### Structure of Liquid Crystal Device

The electro-optical device of the present embodiment is a transmissive liquid crystal device. FIG. 5 is a schematic cross-sectional diagram of the liquid crystal device. Hereinafter, the cross-sectional structure of the liquid crystal device will be described with reference to FIG. 5. Meanwhile, a term “on OO” when used in the embodiment below means arranging something on OO in an adjacent manner, arranging something on OO through another component, or arranging a part of something on OO in an adjacent manner and arranging a part of something on OO through another component.

In the electro-optical device (liquid crystal device), the element substrate 562 and an opposite substrate 563 that constitute the pair of substrates are attached to each other by seal material 564 that is arranged in a substantially rectangular frame shape when viewed in a plan view. The liquid crystal device has a configuration in which the liquid crystal 546 is sealed in an area surrounded by the seal material 564. As the liquid crystal 546, for example, liquid crystal material having positive dielectric anisotropy is used. In the liquid crystal device, a light-blocking film 548 that has a rectangular frame shape when viewed in a plan view and is formed of light-blocking material is formed on the opposite substrate 563 along the vicinity of the inner periphery of the seal material 564, and the area inside the light-blocking film 548 is the display area 540. The light-blocking film 548, for example, is formed of aluminum (Al) that is light-blocking material and is disposed so as to section the outer periphery of the display area 540 on the opposite substrate 563 side and further, is disposed to face the scan line 542 and the signal line 543 in the display area 540 as described above.

As illustrated in FIG. 5, a plurality of pixel electrodes 545 is formed on the liquid crystal 546 side of the element substrate 562, and a first oriented film 565 is formed to cover these pixel electrodes 545. The pixel electrode 545 is a conductive film formed of transparent conductive material such as indium tin oxide (ITO). Meanwhile, the light-blocking film 548 shaped as a lattice is formed on the liquid crystal 546 side of the opposite substrate 563, and the common electrode 547 shaped as a solid flat is formed on the light-blocking film 548. A second oriented film 566 is formed on the common electrode 547. The common electrode 547 is a conductive film formed of transparent conductive material such as ITO.

The liquid crystal device is transmissive, and polarization plates (not illustrated) are respectively arranged to be used on the light-incident side and the light-emitted side of the element substrate 562 and the opposite substrate 563. The configuration of the liquid crystal device is not limited to this. The liquid crystal may be configured to be reflective or semi-transmissive.

As described above, the electro-optical device includes the element substrate 562 that has the display area 540, the drive circuit 551 (the signal line drive circuit 553 is illustrated in FIG. 5), and the mounting area 520. The mounting area 520 is arranged between the display area 540 and one edge 567 of the outer periphery of the element substrate 562. The drive circuit 551 is arranged between the display area 540 and the one edge 567 of the outer periphery of the element substrate 562 and is arranged between the display area 540 and the mounting area 520. That is, the drive circuit 551 is arranged outside the display area 540, and the mounting area 520 is formed further outside the drive circuit 551.

### Vibration of Optical System

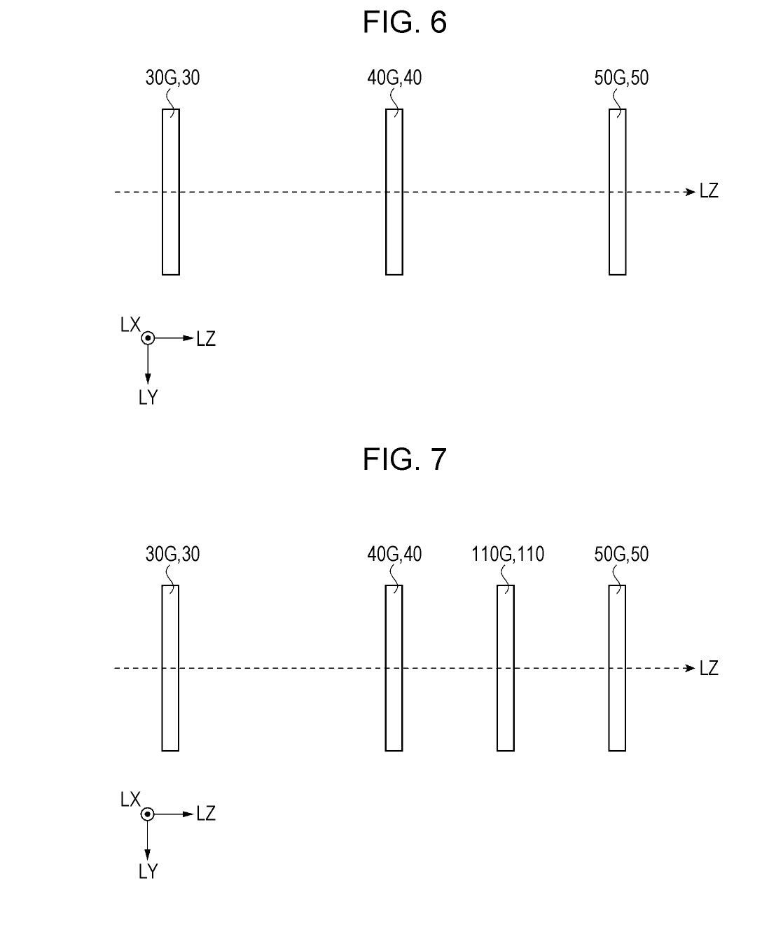

FIG. 6 is a diagram illustrating an example of the optical system (the optical system along the optical axis OP1) from the first electro-optical device to the second electro-optical device according to the first embodiment. Next, vibration performed by the vibration device will be described with reference to FIG. 6. Although the optical system of the green light Gp along the optical axis OP1 is described as an example below, the same content of the description is also applied to the other optical systems of the other colors along the optical axis LZ.

The vibration device vibrates at least one optical component of the first electro-optical device (the dimming light valve 30G), the relay optical system 40 (the optical system 40G), and the second electro-optical device (the color modulation light valve 50G). The dimming light valve 30G that is the first electro-optical device is vibrated in the present embodiment, but apparently, the optical system 40G or the color modulation light valve 50G may be vibrated.

A frequency with which the vibration device vibrates the optical component (referred to as a vibration frequency) is preferably greater than or equal to the frame frequency of video displayed in the second electro-optical device (the color modulation light valve 50G). The frame frequency of a video displayed in the color modulation light valve 50G is 60 Hz in the present embodiment. Thus, the vibration frequency is preferably greater than or equal to 60 Hz. Moires are not visually recognized at all when the frame frequency is 60 Hz, and the vibration frequency is 240 Hz which is four times greater than the frame frequency. Accordingly, ideally, the vibration frequency is greater than or equal to 240 Hz or is four times greater than or equal to the frame frequency. Moires are barely seen when the vibration frequency is greater than or equal to 120 Hz or is greater than or equal to twice the frame frequency. Accordingly, the vibration frequency may be greater than or equal to twice the frame frequency.

By doing so, flares are suppressed by increasing the resolution of the first electro-optical device, and moires caused by the high resolution of the first electro-optical device are vibrated with high speed. Thus, moires are suppressed when the moires are temporally averaged across one vibration cycle. That is, a user who sees a projected image does not visually recognize moires when one vibration cycle is set to a short time smaller than or equal to the frame cycle. By doing so, moires and flares are suppressed, and a high-definition image is displayed with a high contrast ratio. Moires caused by interference of light are noticeable when the size of the pixel 541 of the first electro-optical device is approximately 100 times smaller than the wavelength of the light. The projector 100 modulates visible light, and thus, moires are noticeable when the size of the pixel 541 of the first electro-optical device is smaller than or equal to approximately 75 microns (μm). Accordingly, the invention is particularly effective when the resolution of the first electro-optical device is increased to an extent that the size of the pixel 541 of the first electro-optical device is smaller than or equal to approximately 75 microns (μm).

An amplitude with which the vibration device vibrates the optical component is preferably smaller than or equal to the dislocation length of the assembly of the first electro-optical device and the second electro-optical device. Specifically, the amplitude with which the vibration device vibrates is preferably smaller than or equal to half the length of the pixel 541 of the second electro-optical device. The dislocation length of the assembly of the first electro-optical device and the second electro-optical device is generally smaller than or equal to approximately half the length of the pixel 541 of the second electro-optical device. Thus, when the vibration is such a small one, blurs caused by the vibration of a display image are barely recognized visually, and a clear and high-resolution image can be displayed.

A direction in which the vibration device vibrates is preferably parallel to a plane that is perpendicular to the optical axis (optical axis perpendicular plane). By doing so, a focal point is not dislocated, and a display image does not blur since vibration is not performed in the direction of the optical axis LZ. Furthermore, the direction in which the vibration device vibrates in the optical axis perpendicular plane is preferably translational. Besides the translational vibration in the optical axis perpendicular plane, the direction in which the vibration device vibrates may be rotational around an axis that is parallel to the optical axis LZ (central axis of rotation) in the optical axis perpendicular plane. At this time, the central axis of rotation is preferably positioned outside the electro-optical device (the dimming light valve 30G in this example). By doing so, all of the pixels 541 of the electro-optical device are moved. Besides, the direction in which any of the first electro-optical device (the dimming light valve 30G), the relay optical system 40 (the optical system 40G), and the second electro-optical device (the color modulation light valve 50G) is vibrated may be the direction of the optical axis LZ. Besides the vibration in the optical axis perpendicular plane described above, vibration in the direction of the optical axis LZ may be included in the present description. The present embodiment is also effective in, for example, rotational vibration around an arbitrary axis in the plane that is perpendicular to the optical axis LZ (optical axis perpendicular plane). To summarize, vibration other than the translational vibration in the direction of the optical axis LZ is effective.

The second electro-optical device (the color modulation light valve 50G) is fixed in the present embodiment. Thus, a display image does not vibrate, and blurs caused by vibration barely occur. That is, the quality of an image barely deteriorates. The reason is that gradations of a displayed video slightly changes, but the display is not severely affected since the dimming area is vibrated by the vibration of the first electro-optical device (the dimming light valve 30G). For example, a situation is assumed in which vibration of the first electro-optical device (the dimming light valve 30G) is the severest with a contrast ratio of 1:1000. This is a case where the pixel 541 is displayed as black in the second electro-optical device (the color modulation light valve 50G), and the dimming area that corresponds to this pixel 541 vibrates between white (1) and black (1/1000). Even in this severest situation, only gradations of the luminance of the pixel displayed as black vibrate between 1/1000 and 1/1000000 with respect to the pixel displayed as white accompanied by the vibration, and the luminance of the pixel displayed as black does not change from black. Accordingly, fixing the second electro-optical device (the color modulation light valve 50G) and vibrating the first electro-optical device (the dimming light valve 30G) or the relay optical system 40 (the optical system 40G) can suppress deterioration of the display accompanied by the vibration to a barely problematic level.

### Second Embodiment

### Embodiment Using Shift Optical System

FIG. 7 is a diagram illustrating an example of an optical system (an optical system along the optical axis OP1) from a first electro-optical device to a second electro-optical device according to a second embodiment. Next, a projector according to the second embodiment will be described with reference to FIG. 7. Although the optical system of the green light Gp along the optical axis OP1 is described as an example below, the same content of the description is also applied to the other optical systems of the other light along the optical axis LZ. In addition, the same constituents as those in the first embodiment are given the same reference signs. Thus, description thereof will be omitted without being repeated.

A projector 100 of the present embodiment has a different modulation optical system 90 compared with the projector 100 of the first embodiment. Configurations of the other constituents are substantially the same as those in the first embodiment. The projector 100 of the first embodiment includes the vibration device, but the projector 100 of the present embodiment includes the modulation optical system 90 that has a shift optical system 110 instead of the vibration device as illustrated in FIG. 7. That is, the projector 100 includes an illumination optical system 10 that emits light, the modulation optical system 90 that modulates light emitted from the illumination optical system 10, and a projection optical system 70 that projects light modulated in the modulation optical system 90. The modulation optical system 90 has a dimming system 30 that includes the first electro-optical device, a relay optical system 40, the shift optical system 110, and an image display system 50 that includes the second electro-optical device arranged in series on the optical axis LZ of light emitted from the illumination optical system 10. The relay optical system 40 is arranged on the optical path between the first electro-optical device and the second electro-optical device. The shift optical system 110 is also arranged on the optical path between the first electro-optical device and the second electro-optical device. In addition, the shift optical system 110 vibrates luminous flux that is incident on the second electro-optical device.

The shift optical system 110 is formed by a liquid crystal panel and a birefringent plate that are not illustrated. Applying a voltage to the liquid crystal panel changes the polarization state of light emitted from the liquid crystal panel and shifts the optical path of light emitted from the birefringent plate. Specifically, applying a voltage to the liquid crystal panel shifts the position of the luminous flux emitted from the shift optical system 110 in the optical axis perpendicular plane. Accordingly, alternating the voltage applied to the liquid crystal panel can vibrate the luminous flux emitted from the birefringent plate of the shift optical system 110 in the optical axis perpendicular plane. To summarize, the shift optical system can vibrate luminous flux that is incident on the second electro-optical device in the optical axis perpendicular plane. The same effect as that of the first embodiment can be obtained even in this configuration. In addition, dislocation of the optical axis LZ caused by mechanical vibration after a long time of use is suppressed, and the reliability of the projector 100 is improved since all of the optical systems are fixed in the present embodiment.

A frequency and an amplitude with which the shift optical system 110 vibrates luminous flux emitted from the shift optical system 110 are the same as the frequency and the amplitude with which the vibration device vibrates the optical component in the first embodiment. In addition, a direction in which the shift optical system 110 vibrates the emitted light is translational and parallel to the plane that is perpendicular to the optical axis. Furthermore, two shift optical systems 110 of which the polarization directions are orthogonal to each other may be arranged in series, and the direction in which the two shift optical systems 110 vibrate luminous flux may be rotational around an axis that is parallel to the optical axis in the optical axis perpendicular plane.

Meanwhile, the shift optical system 110 may be included mechanically. In the mechanical shift optical system 110, a transparent flat plate (for example, a transparent resin substrate such as a glass plate and a cyclo-olefin polymer) is arranged to be orthogonal to the optical axis LZ (arranged so that the normal of the transparent flat plate is parallel to the optical axis LZ), and the transparent flat plate is rotationally vibrated around a straight line in the optical axis perpendicular plane as an axis of rotation within a predetermined angular range. For example, setting the axis of rotation to the LX direction can translationally vibrate the optical axis LZ in the LY direction. In addition, two mechanical shift optical systems 110 of which the axes of rotation are orthogonal to each other may be arranged in series on the optical path, and the direction in which the two mechanical shift optical systems 110 vibrate luminous flux may be rotational around an axis that is parallel to the optical axis LZ in the optical axis perpendicular plane.

The invention is not limited to the embodiments described above. Various modifications and improvements may be added to the embodiments described above. A modification example is described below.

### Modification Example 1

### Embodiment Having Different Electro-Optical Device

Next, a projector according to a modification example 1 will be described. The same constituents as those in the first and the second embodiments are given the same reference signs. Thus, description thereof will be omitted without being repeated.

The electro-optical device used in the projector 100 of the first and the second embodiments is transmissive. The electro-optical device used in the projector 100 is not limited to a transmissive one but may be reflective. Configurations of the other constituents are substantially the same as those in the first and the second embodiments.

The first electro-optical device and the second electro-optical device may be configured as the reflective first electro-optical device and the transmissive second electro-optical device, the transmissive first electro-optical device and the reflective second electro-optical device, the reflective first electro-optical device and the reflective second electro-optical device, or the like.

As the reflective electro-optical device, a reflective liquid crystal device or a digital light processing (DLP, registered trademark) device can be used. TFT or a silicon substrate that is called a liquid crystal on silicon (LCOS) substrate may be used in the reflective liquid crystal device. The DLP is a technology that uses a MEMS technology and controls the direction of a micromirror to form an image. The same effect as those of the first and the second embodiments can be obtained even in this configuration.

The entire disclosure of Japanese Patent Application No. 2014-018259, filed Feb. 3, 2014 is expressly incorporated by reference herein.

What is claimed is:

1. A projector comprising:
an illumination optical system that emits light;
a modulation optical system that modulates the light emitted from the illumination optical system;
a projection optical system that projects the light modulated in the modulation optical system; and
a vibration device,
wherein the modulation optical system includes a first electro-optical device, a relay optical system, and a second electro-optical device that are arranged in series on an optical axis of the light emitted from the illumination optical system,
the relay optical system is arranged on an optical path between the first electro-optical device and the second electro-optical device, and
the vibration device vibrates at least one of the first electro-optical device, the relay optical system, and the second electro-optical device.

2. The projector according to claim 1,
wherein a frequency with which the vibration device vibrates is greater than or equal to a frame frequency of a video displayed in the second electro-optical device.

3. The projector according to claim 1,
wherein an amplitude with which the vibration device vibrates is smaller than or equal to a dislocation length of an assembly of the first electro-optical device and the second electro-optical device.

4. The projector according to claim 1,
wherein the second electro-optical device includes a pixel, and
an amplitude with which the vibration device vibrates is smaller than or equal to half a length of the pixel.

5. The projector according to claim 1,
wherein a direction in which the vibration device vibrates is parallel to a plane that is perpendicular to the optical axis.

6. The projector according to claim 5,
wherein the direction in which the vibration device vibrates is translational.

7. The projector according to claim 5,
wherein the direction in which the vibration device vibrates is rotational around an axis that is parallel to the optical axis.

8. The projector according to claim 1,
wherein a direction in which the vibration device vibrates is rotational around an arbitrary axis in a plane that is perpendicular to the optical axis.

9. A projector comprising:
an illumination optical system that emits light;
a modulation optical system that modulates the light emitted from the illumination optical system; and
a projection optical system that projects the light modulated in the modulation optical system,
wherein the modulation optical system includes a first electro-optical device, a relay optical system, a shift optical system, and a second electro-optical device that are arranged in series on an optical axis of the light emitted from the illumination optical system,
the relay optical system is arranged on an optical path between the first electro-optical device and the second electro-optical device, and
the shift optical system is arranged on the optical path between the first electro-optical device and the second electro-optical device and vibrates luminous flux that is incident on the second electro-optical device.

10. The projector according to claim 9,
wherein a frequency with which the shift optical system vibrates the luminous flux is greater than or equal to a frame frequency of a video displayed in the second electro-optical device.

11. The projector according to claim 9,
wherein an amplitude with which the shift optical system vibrates the luminous flux is smaller than or equal to a dislocation length of an assembly of the first electro-optical device and the second electro-optical device.

12. The projector according to claim 9,
wherein the second electro-optical device includes a pixel, and
an amplitude with which the shift optical system vibrates the luminous flux is smaller than or equal to half a length of the pixel.

13. The projector according to claim 9,
wherein a direction in which the shift optical system vibrates the luminous flux is parallel to a plane that is perpendicular to the optical axis.

14. The projector according to claim 13,
wherein the direction in which the shift optical system vibrates the luminous flux is translational.

15. The projector according to claim 13,
wherein the direction in which the shift optical system vibrates the luminous flux is rotational around an axis that is parallel to the optical axis.

16. The projector according to claim 1,
wherein the second electro-optical device is transmissive.

17. The projector according to claim 1,
wherein the second electro-optical device is reflective.
